(19) United States
(12) Patent Application Publication
(10) Pub. No.: US 2023/0303430 A1
(43) Pub. Date: Sep. 28, 2023

(54) FIBERGLASS COMPOSITION INCLUDING REDUCED OXIDIZING AGENT

(71) Applicant: Owens Corning Intellectual Capital, LLC, Toledo, OH (US)

(72) Inventors: Bruno A. Purnode, Newark, OH (US); Scott E. Colangelo, Millersport, OH (US); Christopher J. Bloom, Heath, OH (US); Christopher J. Zins, Hilliard, OH (US); Steven J. Mighton, Granville, OH (US)

(21) Appl. No.: 18/186,417

(22) Filed: Mar. 20, 2023

Related U.S. Application Data
(60) Provisional application No. 63/322,489, filed on Mar. 22, 2022.

(51) Int. Cl. C03C 13/00; C03C 3/091; C09K 5/14

(52) U.S. Cl. CPC C03C 13/00; C03C 3/091; C09K 5/14; C03C 2213/00

(57) ABSTRACT

According to various embodiments, a composition for preparing glass fibers comprises from about 58 wt. % to about 69 wt. % SiO₂, from about 8 wt. % to about 15 wt. % RO, wherein RO is a total amount of MgO and CaO, from about 12 wt. % to about 18 wt. % R₂O, wherein R₂O is a total amount of Na₂O and K₂O, up to about 2 wt. % of a single oxidizing agent, and Fe₂O₃ and FeO. A ratio of Fe²⁺/Fe³⁺ is between 0.02 and 0.1. The glass composition has a log 3 viscosity of between about 911 ° C. and about 1173 ° C.

### CROSS-REFERENCE TO RELATED APPLICATIONS

This application claims priority to and any benefit of U.S. Provisional Application No. 63/322,489, filed Mar. 22, 2022, the content of which is incorporated herein by reference in its entirety.

### FIELD

The present disclosure relates to glass compositions, and more particularly to compositions for preparation of glass fibers having reduced amounts of oxidizing agents while maintaining a suitable or improved oxidation level of the resulting glass.

### BACKGROUND

Many industrial glasses contain iron in their finished melt chemistry as a result of iron being present as a natural impurity in the raw materials. The two iron states in the finished melt chemistry are described as the glass redox. The glass redox is typically defined as the ratio between Fe²⁺ and Fe³⁺ in the finished glass chemistry. The glass redox can be expressed as the ratio between Fe²⁺ and the total amount of Fe in the glass, or as the ratio between Fe²⁺/Fe³⁺ iron states in the glass. Obtaining a glass melt at the correct redox is important for the process of making glass fibers. Air is often introduced into the furnace via bubbling systems to promote oxidation of the glass as well as to increase convection currents in the melter and enhance mixing. Oxidation achieved through such processes may be limited because of the low level of O₂ (e.g., about 21%) in air as well as the limited time the bubbles have to rise to the surface of the molten glass. Accordingly, manganese oxide and/or other oxidizing agents are included to further promote oxidation. However, such oxidizing agents can be costly and can undesirably alter various properties of the resultant glass fibers, such as the thermal conductivity and viscosity.

Accordingly, there is a continuing need for alternative compositions for preparation of glass fibers having reduced amounts of oxidizing agents while maintaining a suitable or improved oxidation level of the resulting glass.

### BRIEF SUMMARY

Various embodiments described herein are directed to compositions for preparation of glass fibers having reduced amounts of oxidizing agents while maintaining a suitable or improved oxidation level of the resulting glass.

According to various embodiments, a composition for preparing glass fibers comprises from about 58 wt. % to about 69 wt. % SiO₂, from about 8 wt. % to about 15 wt. % RO, wherein RO is a total amount of MgO and CaO, from about 12 wt. % to about 18 wt. % R₂O, wherein R₂O is a total amount of Na₂O and K₂O, up to about 2 wt. % of a single oxidizing agent, and Fe₂O₃ and FeO. A ratio of Fe²⁺/Fe³⁺ is between 0.02 and 0.1. The glass composition has a log 3 viscosity of between about 911° C. and about 1,173° C.

In various embodiments, a composition for preparing glass fibers comprises from about 58 wt. % to about 69 wt. % SiO₂, from about 8 wt. % to about 15 wt. % RO, wherein RO is a total amount of MgO and CaO, from about 12 wt. % to about 18 wt. % R₂O, wherein R₂O is a total amount of Na₂O and K₂O, up to about 2 wt. % of an oxidizing agent, and from about 0.1 wt. % to about 1.5 wt. % Fe₂O₃. The glass fibers have a thermal conductivity of greater than 40 W/mK at 1200° C.

According to various compositions, a composition for preparing glass fibers comprises from about 58 wt. % to about 69 wt. % SiO₂, from about 8 wt. % to about 15 wt. % RO, wherein RO is a total amount of MgO and CaO, from about 12 wt. % to about 18 wt. % R₂O, wherein R₂O is a total amount of Na₂O and K₂O, up to about 2 wt. % of a single oxidizing agent. The oxidizing agent consists of an oxide of manganese, cerium, or antimony, and Fe₂O₃ and FeO.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

Unless otherwise defined, all technical and scientific terms used herein have the same meaning as commonly understood by one of ordinary skill in the art to which these embodiments belong. The terminology used in the description is for describing various embodiments only and is not intended to be limiting of the embodiments.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the various embodiments. At the very least, each numerical parameter should be construed in light of the number of significant digits and ordinary rounding approaches.

Notwithstanding that the numerical ranges and parameters setting forth the broad scope of the various embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

The general inventive concepts encompass compositions for preparation of glass fibers having reduced amounts of oxidizing agents, while maintaining a suitable or improved oxidation level of the resulting glass. In particular, various embodiments of the glass composition include from about 60 wt. % to about 69 wt. % SiO₂, from about 8 wt. % to about 15 wt. % RO, where RO is a total amount of MgO, CaO, SrO, and BaO, from about 12 wt. % to about 18 wt. % R₂O, where R₂O is a total amount of Na₂O. K₂O, and Li₂O, up to about 2 wt. % of an oxidizing agent, and iron in the form of Fe₂O₃ and FeO. The glass composition is biosoluble and has properties making it suitable for use in fiber applications, such as insulation. Other advantages will be described in accordance with the various embodiments.

In any of the exemplary embodiments, at least some of the constituents of the glass composition may be incorporated into the glass composition as recycled glass cullet, such as recycled bottle cullet, container cullet, and the like. The use of recycled glass cullet can provide environmental and sustainability advantages and can also provide raw material and energy savings. Accordingly, in various exemplary embodiments, the glass composition includes at least about 50 wt. % of materials that are from recycled glass cullet, such as at least about 50 wt. %, at least about 55 wt. %, at least about 60 wt. %, at least about 70 wt. %, at least about 80 wt. %, or at least about 90 wt. %, depending on the particular embodiment.

The glass composition includes at least about 58 wt. % SiO₂, but no greater than about 69 wt. % SiO₂. Including greater than about 69 wt. % SiO₂ causes the viscosity of the glass composition to increase to an unfavorable level, while including less than about 58 wt. % SiO₂ increases the liquidus temperature and crystallization tendency. In embodiments, the glass composition includes at least about 58 wt. % SiO₂, including, for example, at least about 60 wt. % SiO₂, at least about 61 wt. % SiO₂, at least about 62 wt. % SiO₂, at least about 63 wt. % SiO₂, at least about 64 wt. % SiO₂, or at least about 65 wt. % SiO₂, based on a total amount of oxides present in the glass composition. In any of the exemplary embodiments, the glass composition may include less than about 69 wt. % SiO₂, including, for example, less than about 68 wt. % SiO₂, less than about 67 wt. %, less than about 66 wt. % SiO₂, less than about 65 wt. % SiO₂, or less than about 64 wt. % SiO₂, based on a total amount of oxides present in the glass composition. For example, the glass composition can include from about 58 wt. % to about 69 wt. % SiO₂, from about 60 wt. % to about 69 wt. % SiO₂, from about 61 wt. % to about 68 wt. % SiO₂, from about 62 wt. % to about 67 wt. % SiO₂, or from about 63 wt. % to about 66 wt. % SiO₂, based on a total amount of oxides present in the glass composition, including all ranges and endpoints therebetween. In other exemplary embodiments, the glass composition includes from about 62 wt. % to about 68 wt. % SiO₂, from about 64 wt. % to about 69 wt. % SiO₂, from about 61 wt. % to about 66 wt. % SiO₂, from about 63 wt. % to about 68 wt. % SiO₂, or from about 60 wt. % to about 65 wt. % SiO₂, based on a total amount of oxides present in the glass composition, including all ranges and endpoints therebetween.

In various embodiments, the glass composition includes at least about 8 wt. % RO, but not greater than about 15 wt. % RO, where RO is a total amount of the alkaline earth metal oxides MgO, CaO, SrO, and BaO. The glass composition of various embodiments can include at least about 8 wt. % RO, at least about 9 wt. % RO, at least about 10 wt. % RO, or at least about 11 wt. % RO. In any of the exemplary embodiments, the glass composition includes less than about 15 wt. % RO, including, for example, less than about 14 wt. % RO, less than about 13 wt. % RO, less than about 12 wt. % RO, less than about 11 wt. % RO, or less than about 10 wt. % RO. For example, the glass composition can include from about 8 wt. % to about 15 wt. % RO, from about 9 wt. % to about 14 wt. % RO, from about 10 wt. % to about 13 wt. % RO, or from about 11 wt. % to about 12 wt. % RO, based on a total amount of oxides present in the glass composition, including all endpoints and subranges therebetween. In embodiments, the glass composition includes from about 10 wt. % to about 12 wt. % RO, from about 8 wt. % to about 11 wt. % RO, from about 8 wt. % to about 12 wt. % RO, or from about 9 wt. % to about 12 wt. % RO, based on a total amount of oxides present in the glass composition, including all endpoints and subranges therebetween.

In various embodiments, the glass composition includes an amount of CaO that is greater than an amount of MgO present in the glass composition. For example, in any of the exemplary embodiments, the glass composition may include from about 7 wt. % to about 10 wt. % CaO and from about 1 wt. % to about 5 wt. % MgO, based on a total amount of oxides present in the glass composition. Including greater than about 10 wt. % CaO can lead to a low elastic modulus, while including less than about 7 wt. % CaO can unfavorably increase the liquidus temperature or the viscosity, depending on what CaO is substituted with. Accordingly, some exemplary embodiments, the glass composition includes between about 7.5 wt. % and about 9.5 wt. % CaO, including between about 8.0 wt. % and about 9.2 wt. % CaO, and between about 8.3 wt. % and about 9.0 wt. % CaO, including all endpoints and subranges therebetween. Additionally, including greater than 5 wt. % MgO can increase the liquidus temperature, and including less than 1 wt. % MgO can result in a low modulus when substituted with CaO, or unfavorably increase the viscosity if substituted with SiO₂. Accordingly, in any of the exemplary embodiments, the glass composition may include between about 1.5 wt. % to about 4.5 wt. % MgO, between about 1.8 wt. % and 4.3 wt. % MgO, between about 2.0 wt. % and about 4.0 wt. % MgO, between about 2.5 wt. % and about 3.75 wt. % MgO, and between about 2.8 wt. % and about 3.5 wt. % MgO, including all endpoints and subranges therebetween.

Various embodiments of the glass composition further include alkali oxides (R₂O) in the form of one or more of Na₂O, K₂O, and Li₂O. In various exemplary embodiments, the glass composition includes alkali oxides in the form of Na₂O and K₂O. In some embodiments, the glass composition can be substantially free of lithium-containing compounds. Alkali oxides are present in the glass composition in an amount of at least about 12 wt. %, but not greater than about 18 wt. %, based on a total amount of oxides present in the glass composition. In any of the exemplary embodiments, the glass composition may include at least about 12 wt. % R₂O, at least about 13 wt. % R₂O, at least about 14 wt. % R₂O, or at least about 15 wt. % R₂O, based on a total amount of oxides present in the glass composition. The glass composition of various embodiments can include less than about 18 wt. % R₂O, less than about 17 wt. % R₂O, or less than about 16 wt. % R₂O, based on a total amount of oxides present in the glass composition. For example, the glass composition can include from about 12 wt. % to about 18 wt. % R₂O, from about 13 wt. % to about 17 wt. % R₂O, or from about 14 wt. % to about 16 wt. % R₂O, based on a total amount of oxides present in the glass composition, including all endpoints and subranges therebetween.

In various embodiments, Na₂O is present in the glass composition in an amount that is greater than an amount of K₂O. Na₂O can be present in an amount of from about 11.5 wt. % to about 17.5 wt. %, from about 12 wt. % to about 16 wt. %, or from about 13 wt. % to about 15 wt. %, based on a total amount of oxides present in the glass composition, including all endpoints and subranges therebetween. K₂O can be present in an amount of from about 0.1 wt. % to about 1.5 wt. %, from about 0.3 wt. % to about 1 wt. %, or from about 0.4 wt. % to about 0.75 wt. %, based on a total amount of oxides present in the glass composition, including all endpoints and subranges therebetween.

In embodiments, the total amount of RO and R₂O (e.g., the sum weight percentages of MgO, CaO, SrO, BaO, Na₂O, Li₂O, and K₂O) is less than about 35 wt. %, less than about 30 wt. %, less than about 27 wt. %, or less than about 26 wt. %, based on a total amount of oxides present in the glass composition. In various embodiments, the total amount of RO and R₂O is greater than about ₂O wt. %, greater than about 22 wt. %, or greater than about 25 wt. %, based on a total amount of oxides present in the glass composition.

According to various embodiments, the glass composition further includes Al₂O₃. The Al₂O₃ provides mechanical and fiberizing properties to the glass and, in various embodiments, is included in the glass composition in an amount of greater than 0 wt. % to no more than about 4 wt. %, based on a total amount of oxides present in the glass composition. In any of the exemplary embodiments, the glass composition may include greater than 0 wt. % Al₂O₃, greater than about 0.1 wt. % Al₂O₃, greater than about 0.25 wt. % Al₂O₃, greater than about 0.5 wt. % Al₂O₃, or greater than about 1 wt. % Al₂O₃, based on a total amount of oxides present in the glass composition. The glass composition of various embodiments includes less than about 4 wt. % Al₂O₃, less than about 3 wt. % Al₂O₃, or less than about 2 wt. % Al₂O₃, based on a total amount of oxides present in the glass composition. For example, the glass composition can include from about 0.1 wt. % to about 4 wt. % Al₂O₃, from about 0.2 wt. % to about 3 wt. % Al₂O₃, or from about 0.5 wt. % to about 2 wt. % Al₂O₃, based on a total amount of oxides present in the glass composition, including all endpoints and subranges therebetween. However, it is contemplated that some embodiments can be substantially free of Al₂O₃. Accordingly, Al₂O₃ is considered an optional component in the glass composition of embodiments.

Another optional component in the glass composition is B₂O₃. Although some embodiments are substantially free of B₂O₃, B₂O₃ can be included in the glass composition of other embodiments in an amount of from about 3 wt. % to about 10 wt. %, based on a total amount of oxides present in the glass composition. For example, when included in the glass composition, B₂O₃ can be present in an amount of from about 3 wt. % to about 10 wt. %, from about 4 wt. % to about 9 wt. %, or from about 5 wt. % to about 8 wt. %, based on a total amount of oxides present in the glass composition. In any of the exemplary embodiments, the glass composition may include from about 3 wt. % to about 6 wt. % B₂O₃, from about 7 wt. % to about 10 wt. % B₂O₃, from about 5 wt. % to about 9 wt. % B₂O₃, or from about 8 wt. % to about 10 wt. % B₂O₃, based on a total amount of oxides present in the glass composition.

Various embodiments of the glass composition further comprise iron. The iron can be included as Fe₂O₃, FeO, or a combination of Fe₂O₃ and FeO. In any of the exemplary embodiments, the glass composition may include both Fe₂O₃ and FeO. The glass composition includes Fe₂O₃ in an amount of from about 0.01 wt. % to about 2.0 wt. %, based on a total amount of oxides present in the glass composition. For example, the glass composition can include from about 0.05 wt. % to about 1.75 wt. % Fe₂O₃, from about 0.1 wt. % to about 1.5 wt. % Fe₂O₃, from about 0.13 wt. % to about 1.3 wt. % Fe₂O₃, from about 0.15 wt. % to about 1.15 wt. % Fe₂O₃, from about 0.18 wt. % to about 1.0 wt. % Fe₂O₃, or from about 0.2 wt. % to about 0.85 wt. % Fe₂O₃, based on a total amount of oxides present in the glass composition, including all endpoints and subranges therebetween.

In any of the exemplary embodiments, FeO may also be included in the glass composition. When included, the FeO is present in an amount that is less than the amount of Fe₂O₃ present in the glass composition. A relatively low iron ratio can provide energy efficiency and melting efficiency, and can lead to increased transparency of the resultant glass. Additionally, the use of a particular iron ratio can lead to an increased thermal conductivity which, in turn, makes the glass more diffusive, less absorbing, and transfer heat more easily. In various embodiments, a ratio of Fe²⁺ to Fe³⁺ (i.e., Fe²⁺/Fe³⁺ ) is greater than or equal to about 0.02 and less than or equal to about 0.1. For example, the ratio of Fe²⁺ to Fe³⁺ can be greater than or equal to about 0.02, greater than or equal to about 0.03, greater than or equal to about 0.04, greater than or equal to about 0.05, or greater than or equal to about 0.06. In any of the exemplary embodiments, the ratio of Fe²⁺ to Fe³⁺ can be less than or equal to about 0.1, less than or equal to about 0.09, less than or equal to about 0.08, less than or equal to about 0.07, or less than or equal to about 0.06. For example, the ratio of Fe²⁺ to Fe³⁺ can be from about 0.02 to about 0.1, from about 0.02 to about 0.09, from about 0.02 to about 0.08, from about 0.02 to about 0.07, from about 0.02 to about 0.06, from about 0.03 to about 0.1, from about 0.03 to about 0.09, from about 0.03 to about 0.08, from about 0.03 to about 0.07, from about 0.03 to about 0.06, from about 0.04 to about 0.1, from about 0.04 to about 0.09, from about 0.04 to about 0.08, from about 0.04 to about 0.07, from about 0.04 to about 0.06, from about 0.05 to about 0.1, from about 0.05 to about 0.09, from about 0.05 to about 0.08, from about 0.05 to about 0.07, or from about 0.05 to about 0.06, depending on the particular embodiment.

In order to achieve a particular oxidation state for the glass, various embodiments of the glass composition further include at least one oxidizing agent. The oxidizing agent can be, for example, an oxide of manganese, cerium, or antimony. The oxidizing agent included in various embodiments is selected such that the glass composition is free or substantially free of nitrates and or cerium (e.g., the oxidizing agent is not a nitrate such as sodium nitrate, or cerium). The exclusion of nitrates from the glass composition can reduce NOx emissions resulting from the manufacture of the glass fibers. Additionally, cerium is a known powerful oxidant that may have negative effects on glass product properties. In various exemplary embodiments, the glass composition includes at most one oxidizing agent (i.e., a single oxidizing agent).

The glass fibers may be formed by a process that enables the amount of oxidizing agent in the glass composition to be reduced, as will be described in greater detail below. Accordingly, in various embodiments, the glass composition includes no greater than about 2 wt. % oxidizing agent. The glass composition can include greater than or equal to about 0.01 wt. % oxidizing agent, including, for example, greater than or equal to about 0.02 wt. % oxidizing agent, greater than or equal to about 0.03 wt. % oxidizing agent, greater than or equal to about 0.04 wt. % oxidizing agent, greater than or equal to about 0.05 wt. % oxidizing agent, greater than or equal to about 0.08 wt. % oxidizing agent, greater than or equal to about 0.1 wt. % oxidizing agent, greater than or equal to about 0.25 wt. % oxidizing agent, greater than or equal to about 0.5 wt. % oxidizing agent, greater than or equal to about 0.75 wt. % oxidizing agent, greater than or equal to about 1 wt. % oxidizing agent, greater than or equal to about 1.25 wt. % oxidizing agent, or greater than or equal to about 1.5 wt. % oxidizing agent. Likewise, in any of the exemplary embodiments, the glass composition may include less than or equal to about 2 wt. % oxidizing agent, including, for example, less than or equal to about 1.75 wt. % oxidizing agent, less than or equal to about 1.5 wt. % oxidizing agent, less than or equal to about 1.25 wt. % oxidizing agent, less than or equal to about 1 wt. % oxidizing agent, less than or equal to about 0.9 wt. % oxidizing agent, less than or equal to about 0.75 wt. % oxidizing agent, less than or equal to about 0.5 wt. % oxidizing agent, less than or equal to about 0.25 wt. % oxidizing agent, or less than or equal to about 0.1 wt. % oxidizing agent. For example, the glass composition can include from about 0.01 wt. % to about 2 wt. %, from about 0.02 wt. % to about 1.5 wt. %, from about 0.05 wt. % to about 1.2 wt. %, from about 0.1 wt. % to about 1.1 wt. %, from about 0.25 wt. % to about 0.85 wt. %, or from about 0.3 wt. % to about 0.6 wt. % of a single oxidizing agent, including all endpoints and subranges therebetween. In any of the exemplary embodiments, the glass composition may include from about 1.02 to about 1.08 wt. % oxidizing agent, or between 1.05 wt. % and 1.06 wt. % oxidizing agent.

The glass composition can further include impurities and/or trace materials without adversely affecting the glasses or fibers. These impurities can enter the glass as raw material impurities or can be products formed by the chemical reaction of the molten glass with furnace components. Non-limiting examples of trace materials include zinc, strontium, barium, and combinations thereof. The trace materials can be present in their oxide forms and can further include fluorine and/or chlorine. In embodiments, the glass compositions contain less than 1 wt. %, less than 0.5 wt. %, less than 0.2 wt. %, or less than 0.1 wt. % of each of BaO, SrO, ZnO, ZrO₂, P₂O₅, and SO₃. In embodiments, the glass composition includes less than 5 wt. % of a total amount of BaO, SrO, ZnO, ZrO₂, P₂O₅, and/or SO₃ combined, wherein each of BaO, SrO, ZnO, ZrO₂, P₂O₅, and SO₃, if present at all, is present in an amount of less than 1 wt. %.

In general, the glass compositions disclosed herein are suitable for melting in traditional commercially available refractory-lined glass furnaces, which are widely used in the manufacture of glass reinforcement fibers. In various embodiments, oxygen is introduced into the molten glass to oxidize the iron in the ferrous state (Fe²⁺) to the ferric state (Fe³⁺), thereby reducing the redox ratio. The introduction of oxygen into the molten glass enables the amount of oxidizing agent in the glass composition to be reduced, which may lead to material cost savings.

According to some embodiments, the glass fibers can be formed by any means known and traditionally used in the art. For example, the glass fibers can be formed by obtaining raw ingredients and mixing the ingredients in the appropriate quantities to give the desired weight percentages of the final composition. The method can further improve providing the glass composition in molten form and drawing the molten composition through orifices in a bushing to form a glass fiber.

The glass composition exhibits a low fiberizing temperature (also referred to herein as the log 3 viscosity temperature), which is defined as the temperature that corresponds to a melt viscosity of about 1000 Poise, as determined by ASTM C965-96(2007). According to various embodiments, the glass composition has a log 3 viscosity temperature of from about 900° C. to about 1173° C. For example, the glass composition can have a log 3 viscosity of from about 911° C. to about 1165° C., from about 925° C. to about 1150° C., from about 935° C. to about 1125° C., from about 950° C. to about 1100° C., from about 965° C. to about 1075° C., from about 975° C. to about 1050° C., from about 995° C. to about 1173° C., from about 925° C. to about 1165° C., from about 975° C. to about 1075° C., or from about 925° C. to about 1050° C., including all ranges and endpoints therebetween.

Another fiberizing property of a glass composition is the liquidus temperature. The liquidus temperature is defined as the highest temperature at which equilibrium exists between liquid glass and its primary crystalline phase. The liquidus temperature, in some instances, may be measured by exposing the glass composition to a temperature gradient in a platinum-alloy boat for 16 hours (ASTM C829-81(2005)). At all temperatures above the liquidus temperature, the glass is completely molten, i.e., it is free from crystals. At temperatures below the liquidus temperature, crystals may form.

In some exemplary embodiments, the glass composition has a liquidus temperature below about 915° C. For example, the glass composition can have a liquidus temperature of from about 885° C. to about 915° C., from about 890° C. to about 915° C., from about 895° C. to about 915° C., from about 900° C. to about 915° C., from about 905° C. to about 915° C., from about 885° C. to about 910° C., from about 890° C. to about 910° C., from about 895° C. to about 910° C., from about 900° C. to about 910° C., from about 905° C. to about 910° C., from about 885° C. to about 905° C., from about 890° C. to about 905° C., from about 895° C. to about 905° C., from about 900° C. to about 905° C., from about 885° C. to about 900° C., from about 890° C. to about 900° C., from about 895° C. to about 900° C., including all ranges and endpoints therebetween.

A third fiberizing property is “ΔT”, which is defined as the difference between the fiberizing temperature and the liquidus temperature. According to various embodiments, the glass composition has a ΔT of from about 87° C. to about 176° C. For example, the glass composition can have a ΔT of from about 87° C. to about 176° C., from about 95° C. to about 176° C., from about 100° C. to about 176° C., from about 110° C. to about 176° C., from about 120° C. to about 176° C., from about 130° C. to about 176° C., from about 87° C. to about 165° C., from about 95° C. to about 155° C., from about 100° C. to about 145° C., or from about 110° C. to about 130° C., including all ranges and endpoints therebetween.

The fibers may be used to form insulation products or nonwoven mats. To form an insulation product, fibers produced by the rotating spinner are drawn downwardly from the spinner towards a conveyor by a blower. As the fibers move downward, a binder composition is sprayed onto the fibers and the fibers are collected into a high loft, continuous blanket on the conveyor. The fiber-binder matrix gives the insulation product resiliency for recovery after packaging and provides stiffness and handleability so that the insulation product can be handled and applied as needed in the insulation cavities of buildings. The binder composition also provides protection to the fibers from interfilament abrasion and promotes compatibility between the individual fibers.

The blanket containing the binder-coated fibers is then passed through a curing oven and the binder is cured to set the blanket to a desired thickness. After the binder composition has cured, the fiber insulation may be cut into lengths to form individual insulation products, and the insulation products may be packaged for shipping to customer locations. One typical insulation product produced is an insulation batt or blanket, which is suitable for use as cavity (e.g., wall, floor, ceiling) insulation in residential dwellings or other buildings, and which might also be used to insulate an attic or other portions of a building. Such a batt or blanket is typically a unitary structure that may be relatively flexible or rollable. Another common insulation product is air-blown or loose-fill insulation, which is suitable for use as sidewall and attic insulation in residential and commercial buildings as well as in hard-to-reach locations. Such loose-fill insulation is often formed as many relatively small discrete pieces, tufts, or the like, which may or may not have a binder applied thereto. Loose-fill insulation can also be formed of small cubes that are cut from insulation blankets, compressed, and packaged in bags.

The insulating performance of a thermal insulation material (known as R-value) is mainly determined by the ratio of the material's thickness divided by its thermal conductivity (k), which measures the amount of heat (in BTUs per hour) that will be transmitted through one square foot of 1-inch thick insulation in order to cause the temperature to rise or fall one degree from one side of the insulation to the other. The R-value is defined by Equation (1):

Equation (1)

R=T₁/k (1)

where “T₁” is the thickness of the insulation product expressed in inches, “k” is the thermal conductivity of the insulation product expressed in BTU·in/hr·ft^{2.}° F. (SI unit for thermal conductivity is watts/meter/Kelvin (W/mK)), and “R” is the R-value of the insulation expressed in hr·ft^{2.}° F./BTU.

In any of the exemplary embodiments provided herein, a fibrous insulation product formed with the subject glass fibers may achieve an R-value between 11 and 40, such as, for example, between 15 and 35, and between 20 and 30, including all endpoints and subranges therebetween.

As can be derived from Equation 1, the R-value of an insulation product is increased with increased thickness or with decreased k-value. The lower the thermal conductivity for a material, the better it insulates. The thermal conductivity is dependent upon a number of variables including density, fiber diameter, and glass composition.

In various embodiments, the fibrous insulation product has a thermal conductivity of greater than or equal to about 40 W/mK at 1200° C. The glass composition can have a thermal conductivity of greater than or equal to about 40 W/mK, greater than or equal to about 50 W/mK, greater than or equal to about 60 W/mK, greater than or equal to about 70 W/mK, greater than or equal to about 80 W/mK, greater than or equal to about 90 W/mK, greater than or equal to about 100 W/mK, or greater than or equal to about 110 W/mK at 1200° C. In various embodiments, the glass composition has a thermal conductivity of less than or equal to about 150 W/mK at 1200° C. The glass composition can have a thermal conductivity of less than or equal to about 150 W/mK, less than or equal to about 140 W/mK, less than or equal to about 130 W/mK, less than or equal to about 120 W/mK, less than or equal to about 110 W/mK, less than or equal to about 100 W/mK, or less than or equal to about 90 W/mK. For example, the glass composition can have a thermal conductivity of from about 40 W/mK to about 150 W/mK, from about 40 W/mK to about 140 W/mK, from about 40 W/mK to about 125 W/mK, from about 40 W/mK to about 100 W/mK, from about 40 W/mK to about 75 W/mK, from about 50 W/mK to about 150 W/mK, from about 50 W/mK to about 140 W/mK, from about 60 W/mK to about 150 W/mK, or from about 60 W/mK to about 140 W/mK.

Alternatively, the fibers may be further processed in a conventional manner suitable for the intended application. For instance, in some exemplary embodiments, the glass fibers are sized with a sizing composition known to those of skill in the art. The sizing composition is in no way restricted, and may be any sizing composition suitable for application to glass fibers. The sized fibers may be used for reinforcing substrates such as a variety of plastics where the product's end use requires high strength and stiffness and low weight.

The general inventive concepts have been described above both generally and with regard to various specific exemplary embodiments. Although the general inventive concepts have been set forth in what are believed to be exemplary illustrative embodiments, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and do not limit the scope of the general inventive concepts described herein.

### Example 1

Exemplary glass compositions according to the present invention were prepared by mixing batch components in proportioned amounts to achieve a final glass composition with the oxide weight percentages set forth in Table 1, below.

| | Ex. 1 | Ex. 2 | Ex. 3 |
|---|---|---|---|
| SiO₂ | 66.60 | 66.55 | 66.56 |
| Al₂O₃ | 2.36 | 2.21 | 2.26 |
| CaO | 8.58 | 8.60 | 8.84 |
| MgO | 1.00 | 0.93 | 1.00 |
| CaO + MgO | 9.58 | 9.53 | 9.84 |
| Na₂O | 12.64 | 12.57 | 12.48 |
| K₂O | 0.77 | 0.79 | 0.78 |
| Na₂O + K₂O | 13.41 | 13.36 | 13.26 |
| B₂O₃ | 6.27 | 6.39 | 6.57 |
| Fe₂O₃ | 0.32 | 0.31 | 0.27 |
| FeO | 0.02 | 0.02 | 0.01 |
| MnO | 1.06 | 1.05 | 1.13 |
| TiO₂ | 0.041 | 0.044 | 0.03 |
| SO₃ | 0.07 | 0.06 | 0.07 |
| sum | 99.73 | 99.52 | 100.0 |
| Total Fe | 0.23 | 0.23 | 0.192 |
| Total Fe²⁺ | 0.02 | 0.02 | 0.008 |
| Fe³⁺ | 0.209 | 0.201 | 0.185 |
| Fe²⁺/Fe³⁺ | 0.074 | 0.078 | 0.042 |

To the extent not already described, the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A composition for preparing glass fibers, the composition comprising:
from about 58 wt. % to about 69 wt. % SiO₂;
from about 8 wt. % to about 15 wt. % RO, wherein RO is a total amount of MgO and CaO;
from about 12 wt. % to about 18 wt. % R₂O, wherein R₂O is a total amount of Na₂O and K₂O;
up to about 2 wt. % of a single oxidizing agent; and
Fe₂O₃ and FeO, wherein a ratio of Fe²⁺/Fe³⁺ is between 0.02 and 0.1;
wherein the composition having a log 3 viscosity of between about 911° C. and about 1,173° C.

2. The composition according to claim 1, wherein the glass composition is free of nitrates.

3. The composition according to claim 1, wherein the composition further comprises from about 3 wt. % to about 10 wt. % B₂O₃.

4. The composition according to claim 1, wherein the composition comprises less than about 4 wt. % Al₂O₃.

5. The composition according to claim 1, wherein the oxidizing agent consists of an oxide of manganese, cerium, or antimony.

6. The composition according to claim 1, wherein CaO is present in the composition in an amount that is greater than an amount of MgO present in the composition.

7. The composition according to claim 1, wherein the total amount of MgO and CaO is less than about 12 wt. %.

8. A composition for preparing glass fibers having a thermal conductivity of greater than 40 W/mK at 1200° C., the composition comprising:
from about 58 wt. % to about 69 wt. % SiO₂;
from about 8 wt. % to about 15 wt. % RO, wherein RO is a total amount of MgO and CaO;
from about 12 wt. % to about 18 wt. % R₂O, wherein R₂O is a total amount of Na₂O and K₂O;
up to about 2 wt. % of an oxidizing agent; and
from about 0.1 wt. % to about 1.5 wt. % Fe₂O₃.

9. The composition according to claim 8, wherein the thermal conductivity is from about 40 W/mK to about 150 W/mK at 1200° C.

10. The composition according to claim 8, wherein the composition further comprises FeO.

11. The composition according to claim 10, wherein a ratio of Fe²⁺/Fe³⁺ is between 0.02 and 0.1.

12. The composition according to claim 8, wherein the composition is free of nitrates.

13. The composition according to claim 8, wherein the composition includes up to one oxidizing agent.

14. The composition according to claim 8, wherein the oxidizing agent consists of an oxide of manganese, cerium, or antimony.

15. The composition according to claim 8, wherein the composition further comprises from about 3 wt. % to about 10 wt. % B₂O₃.

16. The composition according to claim 8, wherein the composition comprises less than about 4 wt. % Al₂O₃.

17. A composition for preparing glass fibers, the composition comprising:
from about 58 wt. % to about 69 wt. % SiO₂;
from about 8 wt. % to about 15 wt. % RO, wherein RO is a total amount of MgO and CaO;
from about 12 wt. % to about 18 wt. % R₂O, wherein R₂O is a total amount of Na₂O and K₂O;
up to about 2 wt. % of a single oxidizing agent, wherein the oxidizing agent consists of an oxide of manganese, cerium, or antimony; and
Fe₂O₃ and FeO.

18. The composition according to claim 17, having a thermal conductivity of greater than 40 W/mK at 1200° C.

19. The composition according to claim 17, having a log 3 viscosity of between about 911° C. and about 1173° C.

20. The composition according to claim 17, wherein the single oxidizing agent consists of manganese oxide and is present in an amount between 1.02 wt. % to 1.08 wt. %.
